(19) United States
(12) Patent Application Publication
(10) Pub. No.: US 2010/0063852 A1
(43) Pub. Date: Mar. 11, 2010

(54) Automated Insurance Services System

(75) Inventor: Hâkan Toll, Knivsta (SE)

Correspondence Address: POTOMAC PATENT GROUP PLLC, P. O. BOX 270, FREDERICKSBURG, VA, 22404, US

(73) Assignee: VALUEGUARD AB, Knivsta (SE)

(21) Appl. No.: 12/531,376

(22) PCT Filed: Apr. 4, 2008
(86) PCT No.: PCT/SE2008/000245

§ 371 Date: Sep. 17, 2009

Related U.S. Application Data
(60) Provisional application No. 60/921,818, filed on Apr. 4, 2007.
(60) Provisional application No. 60/974,147, filed on Sep. 21, 2007.

(51) Int. Cl. G06Q 10/00

(52) U.S. Cl. 705/4

(57) ABSTRACT

Methods and systems for generation of an insurance to protect the policy-holder of an object which is part of a market against changes in an index related to this market under a period of time are provided.

### BACKGROUND

This invention relates to methods and systems for providing automated insurance services, and in particular to event-driven machines for automated provision of insurance services to cope with large data volumes.

At present, there is no cost-efficient way for an individual home owner to protect the value of his or her investment during periods of time when residential real estate values are declining. Traditionally, either the homeowner waits to sell the home when the real estate markets recover and a profit on the sale can be made, or if the home owner is forced to move due to a job change or other relocation pressure, he or she sells at a loss. This is in contrast to the situation for other means to protect the home owner's investment, such as traditional insurance policies that cover destruction or damage from causes such as fire (including smoke damage); windstorm (including hail); weight of ice, snow, or sleet; explosion; crime (including theft, vandalism and malicious mischief); accidental major leak or overflow of water; check forgery and credit fraud; etc.

New markets starting up at the moment (for instance, the Chicago Mercantile Exchange (CME) is to begin trading housing futures for ten large U.S. metropolitan regions) seem well designed to attract institutional investors, hedge funds, and professionals. Nevertheless, such a market is not well suited for the mass market or for most private home owners. A homeowner could buy a put option for protection from negative changes in the real estate market, but put options are not designed for a consumer market and could cost quite a lot, e.g., the price of a put option due in a few years could well be in the range of 10% of the real estate value. Such an option is also limited in time and must be exercised at a certain date or a certain period regardless of whether the timing is good or not.

The typical futures trading market is too advanced to attract most homeowners. In order to attract ordinary people, a market needs to be rearranged to consumer products that typical people can relate to, e.g., insurances and funds. In addition, the requirements of a product platform that will have many customers and many different data transactions bear consideration. A consumer-friendly system can be expected to require high volumes, many transactions, and a lot of user requests to the system. For a system working towards an index, a system that nobody has yet created, an insurance system running an application that can simulate the business scenarios for all stakeholders can be useful. No such system exists that has a scalable, large volume, high calculation speed, user-friendly user interfaces, and transparency.

Risks associated with a real estate market can be significant. Many financial crises have created huge price decreases on the real estate market. A few examples of such financial crises at the end of the last century are Spain (in 1977), Norway (in 1987), Finland (in 1991), Sweden (in 1991), and Japan (in 1992). In the financial crisis in Sweden in 1991, to take one example, private-home real estate values decreased by more than 30% in two years, and the recovery period was as long as eight years. A solution is needed that can handle this type of situation also. Several stakeholders need data from a system to study and control risk development and risk scenarios in such situations.

### SUMMARY

It is an object of the present invention to overcome or at least reduce the problems as outlined above.

It is another object of the present invention to provide a method and a system whereby an investment in a unique object can be protected. It is also the intention to create a good business for all involved parties and full control and transparency of the risk exposure.

One of the main advantages with the solution is that it can cope with high volumes of transactions. There will be several index series, many customers and many transactions in the system. This is not possible to solve without a computerized solution.

These objects and others are obtained by the method and system as set out in the appended claims. Hence in accordance with the present invention a method and a system for generation an insurance to protect the policy-holder of an object which is part of a market against changes in an index related to this market under a period of time is provided.

### BRIEF DESCRIPTION OF THE DRAWINGS

The invention will be better understood by reading this description with reference to the accompanying drawings, in which:

FIGS. 1, 1A illustrate object unit instances and payment flows;

FIG. 2 illustrates several instantiated object units and payment flow;

FIG. 3 illustrates how object units run on a server;

FIG. 4 illustrates how several agreements can coexist;

FIG. 5 illustrates possible implementation in a network;

FIG. 6 illustrates possible implementation of user requests;

FIG. 7 illustrates how different compensation windows can co-exist; and

FIG. 8 is a flowchart of an exemplary method of determining a compensation for an insurance contract.

### DETAILED DESCRIPTION

As described in this application, the inventor has provided methods and systems for generating insurances to protect policy-holders of an object which are parts of a market against changes in an index related to this market under a period of time. The present invention overcomes or at least reduces the problems discussed above and provides methods and systems whereby an investment in a unique object, such as real estate, can be protected with full control and transparency of the risk exposure. An advantage of such methods and systems is that they can cope with high volumes of transactions. As described below, several index series, many customers, and many transactions can be accommodated by a suitably configured computer system.

It will be noted that this application is written in terms of “insurance”, but this should be understood in a broad sense. “Insurance” can be a promise, a guarantee, a protection, or a financial product. In some countries, insurance might be considered a guarantee or a protection offered by an insurance company or by a company other than an insurance company. Thus, the insurance company discussed below can be another type of company.

In addition, it is possible to know the status of the system at all times. A system user can check risk exposure or business value for particular user categories. Many different customers, resellers, insurance companies, etc. can be accommodated, and any such user may send specific user requests to the system and see how the user's business is developing.

It will also be appreciated that many different index or customer-development scenarios in the past, present, or future can be simulated. For example, payment rules and other system parameters can be varied to explore the consequences of such variation, providing a unique way of handling the risk and business for all involved parties. Different user scenarios can be simulated based on user requests, and loading a system with past, present, or future index values, customer data, and user parameters enables any user scenario to be simulated. Thus, the authorities can run user requests and see the risk exposure for different index and customer base development scenarios; stockholders can run different scenarios to estimate business values; end-customers can test different scenarios based on their unique competences; resellers can see how their businesses are developing in certain scenarios; reinsurance companies can check their risk exposures, etc.; and on and on. All involved parties can build up their own what-if ideas and understand what the system predicts for certain scenarios or how risk-exposed a company may be, which gives business value and control to all involved parties.

The systems and methods described in this application can update insurance coupled to private real estate price risk agreements automatically. In accordance with the present invention, an insurance is generated that protects the policy-holder of an object and is part of a market against changes in an index related to this market under a period of time. The methods and systems described here make it possible to handle many insurance agreements, agreements that use indexes as bases for compensation requests, in parallel. Insurance proposals can be evaluated by end-customers and resellers. Insurance risks in one contract or for a whole stock of contracts can also be monitored by using information gathered by the object unit described below.

Insurance agreements between an insurer and a policy holder are typically placed by an exchange of a number of paper documents. This becomes difficult when many event-driven user requests from different stakeholders are generated. Large data volumes, many scenarios to run, and large volumes of customers and user requests necessitate a computerized system, which is more accurate and able to cope with the large volumes. Such a computerized system also needs a lot of index data and an ability to view past, current, and future index developments in different regions, which also entails a lot of data. The computerized system may be instantiated many, many times and may handle a lot of data and operations on the data. In this application, operations on date are generally called user requests.

The inventor has recognized that such a computerized system is a very efficient machine, which is called an “object unit” in this application, can handle terms and conditions for insurances in large volumes. An object unit, or computerized system, is advantageously scalable when user-request and data traffic add up to cope with more and more insurance contracts. Also, an object unit can use past, current, and new data to simulate different scenarios for specific user data, specific pricing data, and specific risk data, to take just a few examples.

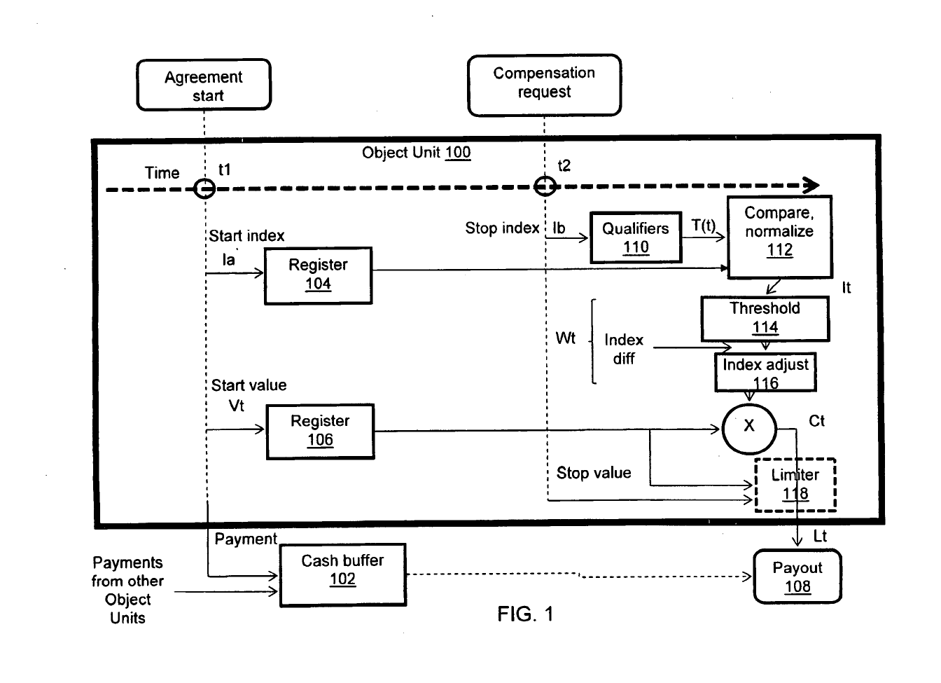

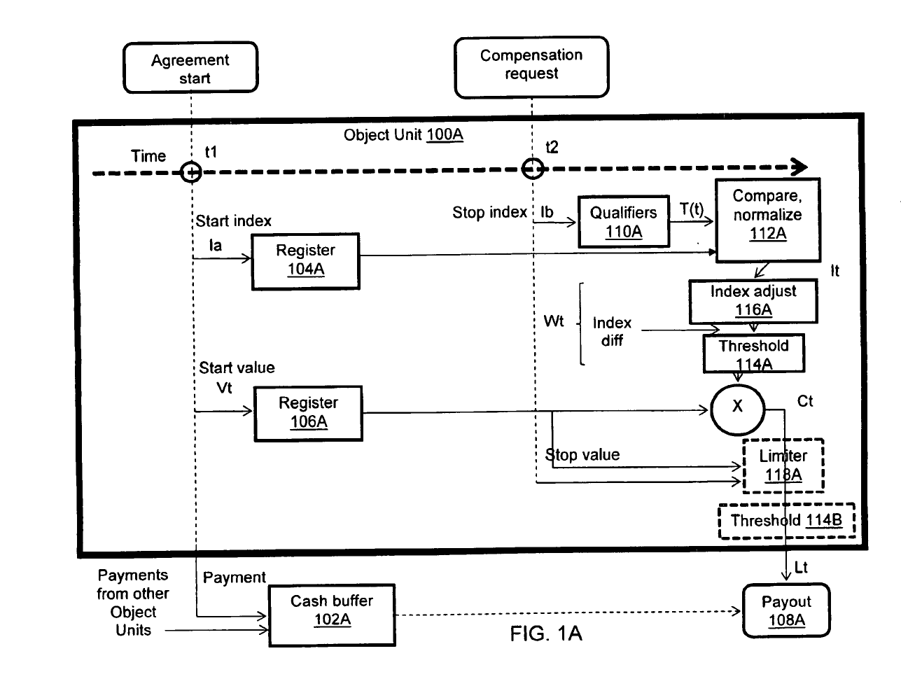

FIG. 1 depicts an object unit 100, i.e., a computer system, in accordance with this invention. Time is generally indicated in FIG. 1 by a dashed arrow, with later times toward the right-hand side. The object unit 100 saves all user parameters necessary for an insurance contract at an Agreement start time t1, and may also define the payments due from the customer (e.g., the policy holder) during the contract. Such payments may occur once, e.g., at the start of the contract, or several times, and are sent to a cash buffer 102, which preferably includes a security reserve and may receive payments from other instantiations of the object unit. In a typical insurance contract, a payment plan is defined, and the object unit 100 triggers the corresponding payments.

At the start of an insurance contract with a customer, i.e., at time t1 or thereabouts, the object unit 100 sets a start index value Ia that is stored in a suitable register 104 and a start value Vt for the insured value, which may be generally a function of time V(t), that is stored in a register 106.

A compensation request under the contract may be received at a time t2, at which point the cash buffer computes a corresponding payout 108, deciding if and how big the payout 108 should be. The artisan will understand that the cash buffer 102 can also compute simulated payouts in response to simulated compensation requests at any desired time t2. The cash buffer 102 may thus be a form of payment facility system that is more or less separate from the system implementing the object unit 100, which for example saves values related to a payment plan and triggers payments and a payment plan that can normally be done in another part of the system.

Thus, the term “cash buffer” is intended simply to express, for example, the idea that values from the payment plan are to be stored and then retrieved with a suitable payment facility system that may include an electronic memory with stored information about cash reserves and one or more electronic processors that perform the computations described above. The object unit 100 performs the computations and controls the cash buffer 102 (payment facility system) so as to disburse the payout 108.

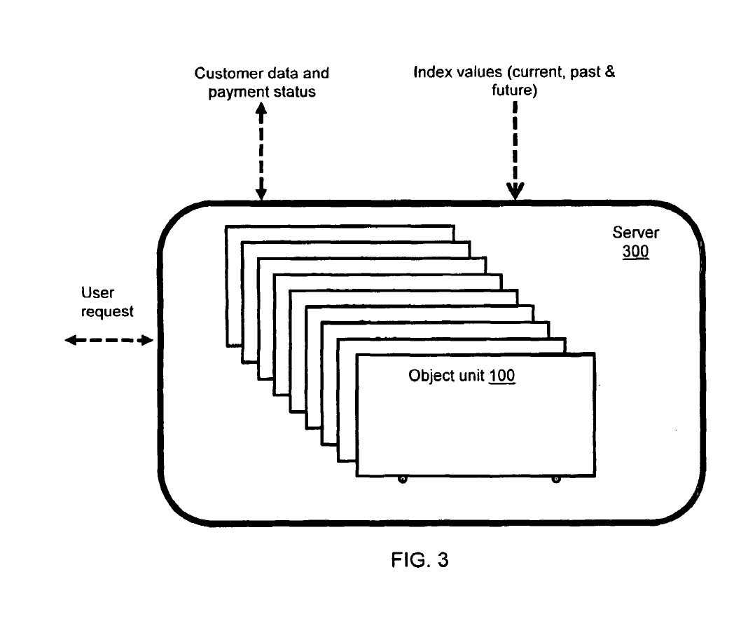

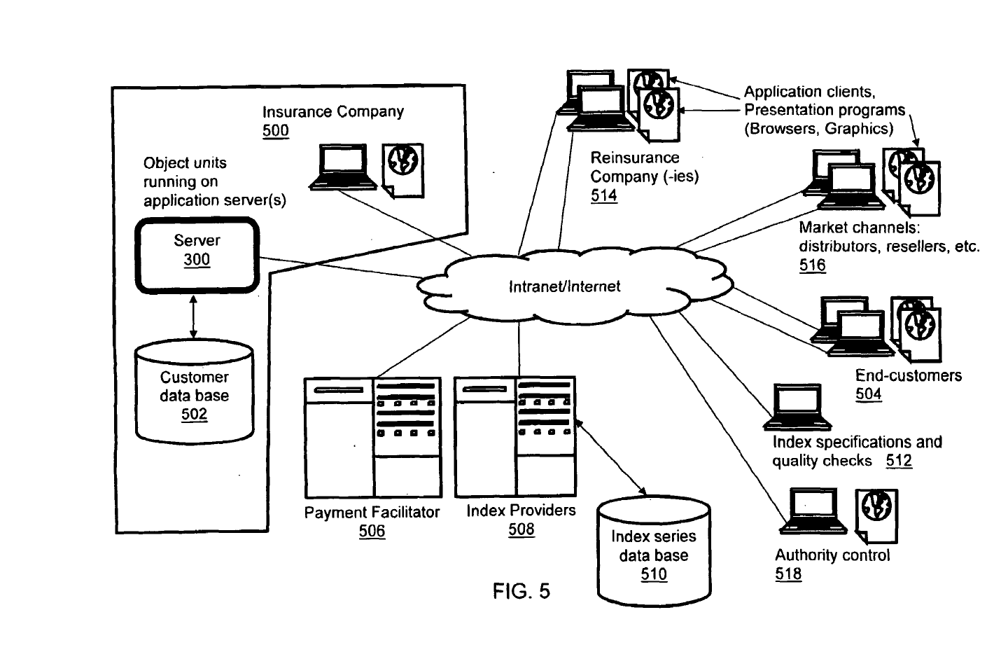

On receiving a compensation request, which in general may occur at any time, the object unit 100 obtains a stop index value Ib. As described below, index values, such as the start index value Ia and the stop index value Ib, can be received from an index provider, as illustrated in FIG. 5, which sends the index values to the object unit 100 via index value signals, as illustrated in FIG. 3.

Besides obtaining the stop index value Ib upon receiving a compensation request, the object unit 100 checks one or more qualifiers 110, which are applicable contract terms and conditions. For example, the qualifiers unit 110 can check the duration time of the agreement, whether an elimination time has passed, whether all necessary valid documentation has been provided by the policy holder. The state(s) of the qualifiers 110 are generally expressed by a function T(t), the value of which at any particular time reflects the evaluation of the qualifier(s) 110. For example, if all evaluated terms and conditions are met, the value of T(t) can be positive. Generally, the qualifiers unit 110 returns a “success” indication if all terms and conditions are met and returns an “unsuccessful” indication if all terms and conditions are not met.

It will be appreciated that there can be many contract terms and conditions that need to be evaluated in order to do a payout calculation. As depicted in FIG. 1, the compensation request signal triggers the action of the qualifiers unit 110. If all terms and conditions are met, the stop index value Ib can now be fed to the compare and normalize unit 112 that uses the stop index value to compute an index difference. If the qualifiers unit 110 determines that all terms and conditions are not met, no further calculations need to be done as the compensation request was unfavorable. Normally, the stop index value Ib, or more typically, the compensation request, triggers the qualifiers unit 110 that then passes the stop index value to the compare and normalize unit 112 under predetermined conditions,

Based on the value of T(t), which reflects the stop index value Ib, and on the start index value Ia, the compare and normalize unit 112, which may realized by a suitably programmed processor or suitably configured logic circuits, computes the value It of an index change function I(t). The compare and normalize unit 112 computes the index difference value It as follows:

It=(Ia−Ib)/Ia

in which the values Ia, Ib are as described above.

The index change value It can be used in several ways; as shown in FIG. 1, a suitable processor 114 compares the value It to a threshold, which may be adjustable, and produces an index change W(t). For example, the threshold unit 114 can check if there are limitations to the size of the index change, if there is a maximum index change, or if there is a part of the index change that should be removed. The index value can be further modified by an index adjust unit 116, which for instance can multiply the index by a factor (typically in the range of 0 to 1) or apply another function to the index.

The operations of the threshold unit 114 and index adjust unit 116 can be considered a compensation amplitude that is applied to the index change function I(t) to produce the index change function W(t) and that corresponds very much to the specifics of the insurance contract being considered. In general, W(t) is a function that checks the magnitude of the index change and can subtract or add to this, and it can also apply factors, e.g., multiplicative factors, corresponding to specific contract features.

After the operation of the index adjust unit 116, how the index change should affect the payout 108 is quantified, and that quantity is multiplied by the start value Vt to give the absolute value Ct of the payout 108 that is generally expressed by a function C(t). The quantities T, I, V, and C are further described below.

Some of the products can be limited by how the underlying object business is developing in itself. If the underlying business has developed well, maybe there should be no payout at all. For instance, a policy holder has made a net profit on his investment. Then he gets no compensation from certain products. It could also be the case that the insurance agreement gives compensation as long as the total investment is still a loss. This can be set by a limiter 118 (which is optional as indicated by the dashed lines) that uses the value Ct, the start value Vt, and a stop value for the insured value, e.g., the sales value of the underlying object to determine a payout according to a limit function L(t). The L(t) function might also limit the payout 108 according to setup rules in the limiter 118.

If there is to be a payout 108 (e.g., payment on a claim for compensation), the object unit 100 controls the cash buffer 102, e.g., by sending the buffer 102 a suitable request, such that a payout of a certain amount is made.

The artisan will understand that the object unit 100 and functionality described in connection with FIG. 1 are readily implemented in a number of ways, for example, by one or more electronic processors configured by suitable programming software. In addition, the order of the different functional blocks depicted in FIG. 1 can of course be arranged in several different ways to help optimize operations. For example, the functionalities of the components shown in FIG. 1A generally correspond to the functionalities of the components shown in FIG. 1, with the components in FIG. 1A being identified by the same reference numerals but with an “A” or a “B” added.

As depicted in FIG. 1A, an object unit 100A has the order of a threshold unit 114A and an index adjust unit 116A reversed in comparison to the object unit 100, with the index adjust unit 116A receiving the output of a compare and normalize unit 112A and providing a signal to the threshold unit 114A. The threshold unit 114A checks whether maximum compensation is reached. If so, the unit 114A returns a suitable signal indicating the maximum compensation, and otherwise the unit 114A returns a signal indicating the index difference, which may be called Dt. The multiplier after the unit 114A multiplies the start value Vt from the register 106A by the index difference Dt, and the limiter 118A determines the difference between the start value Vt and a stop value, which can be the sale price of the underlying object(s). The limiter 118A can then remove positive tax effects from the difference, which can be called D′t, and compare the difference D′t with the difference Dt, for example by evaluating Min(D′t, DO, where Min(x,y) is a minimum function that returns the value x if x≦y, and the value y otherwise. This step is useful when the payout 108A is to be limited based on the business of the underlying object(s).

Also, it can be more favorable to implement the functionality of the threshold unit 114A after the limiter 118A or as shown in FIG. 1A to include an extra threshold unit 1148 after the limiter 118A. The unit 114B can be used to determine for instance an excess after all other calculations are done. Thus, the threshold unit 114B takes the difference Dt or D′t and subtracts an excess amount, which may typically be in the range of a few percent of the insured amount, here called the start value Vt, to determine the net compensation Lt. The net compensation amount Lt is forwarded to the part of the system that handles payouts 108A.

It will be understood that the realization of an object unit 100, 100A can be done in different parts of a computer system and in one or more software or hardware modules. As described in this application, such realizations involve storing a set of parameter values at the start of an agreement start (or shortly before or after the start). The set of values includes mainly the start index value Ia and the start value Vt. Of course, together with that information, a customer identity is normally also stored (as well as a lot of other parameters). The realizations also involve retrieving the stored set of parameter values and performing a number of computations based thereon in response to a compensation request, or before or after the compensation request. The functionalities in an object unit can be implemented in the sequences described above or in other sequences or in parallel, which can be understood by studying the mathematical formulas described in this application. Moreover, part of the implementation of the methods and apparatus described in this application can extend outside an object unit or computer system. For instance, some of the qualifiers could be determined by manually checking payment(s) for an agreement or verifying a sale transaction of underlying object(s). Nevertheless, by implementation of the object unit, risks and compensation can be calculated in real time on one or several agreements at the same time and different scenarios can be simulated.

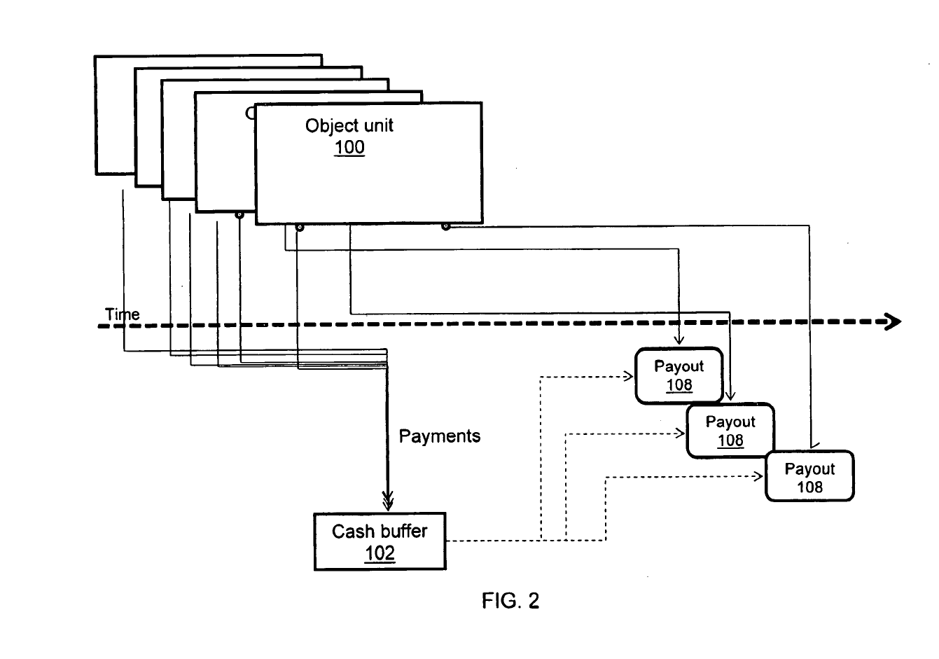

FIG. 2 illustrates an example of several object units 100 activated by several respective insurance contracts with several respective customers. Over time, one or more customers make payments, sell their objects, and submit compensation requests leading to payouts 108 from the cash buffer 102. One feature of the system that can be seen in FIG. 2 is that the customers typically are spread out in time, which is depicted by the different positions of the object units 100 with respect to the horizontal dashed line representing time. Thus, all customers are not taken into the system simultaneously but customers are added and customer requests are event triggered at different times. Also, all customers do not sell the properties at the same time, and so the corresponding compensation requests occur at different times. A benefit of this temporal dispersion is that several customers can share the same insurance system, i.e., the same combination of electronic hardware and software. Thus, the insurance policy gets less expensive than it would be if each customer would have bought their own derivative at a derivative market to hedge his price risk.

FIG. 3 illustrates how several object units 100, each of which comprises a software program, can be run on a computer server 300. The server 300 then is preferably able to handle several different types of user requests. For example, a type of user requests can order data to be retrieved from a data base of user information (see data base 502 in FIG. 5), enabling customer data and payment status information to be requested. Another type of user requests can order index data, such as past, present, and estimated future index values, to be supplied from the system. As explained above, all parties involved with the system advantageously can submit their own particular user requests to the server 300 and have their own particular needs met.

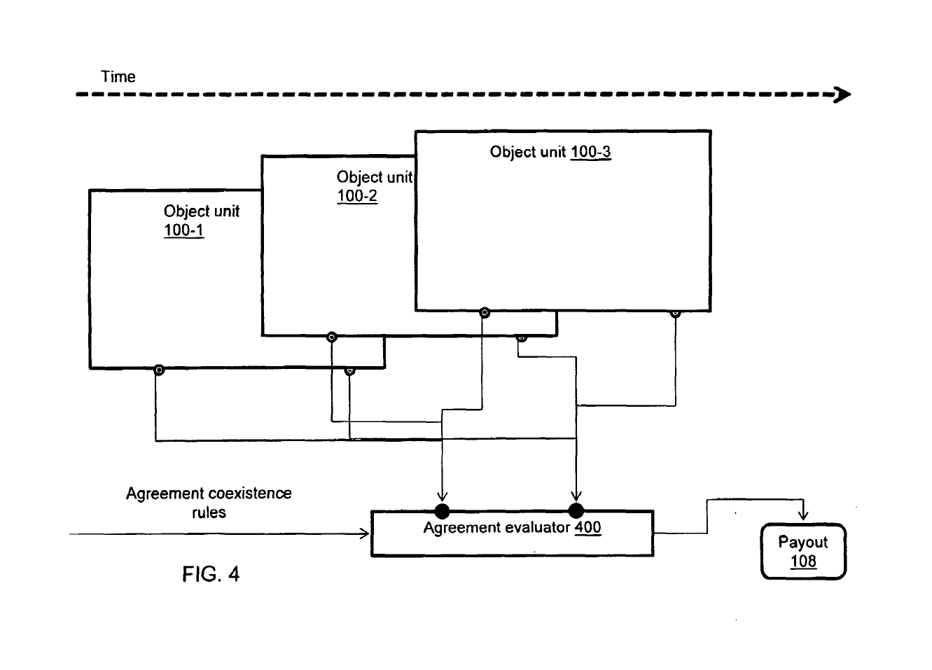

FIG. 4 illustrates an aspect of the system that is currently believed to be particularly significant. Since insurance agreements described above are fixed in time with a certain start index value and a certain start value, a user such as a customer might want to update or upgrade the insurance as time passes, indicated in FIG. 4 by the horizontal dashed line. For example, the index might have gone up for a period of time, and so the customer would like to look at the resulting new increased value. As depicted in FIG. 4, a customer having an agreement represented by an object unit 100-1 can add a new agreement represented by an object unit 100-2, i.e., a new start index value Ia and/or a new start value Vt. As an existing customer already in the system, the customer has made a payment already for the old agreement and he can now benefit from this buying a new product or an upgrade. Also as depicted in FIG. 4, the customer can add further new agreements, one of which is represented by an object unit 100-3, that correspond to further new start index values Ia and/or new start values Vt. Thus, FIG. 4 illustrates how a customer can have several agreements in parallel in the system, which preferably then includes an agreement evaluator unit 400, which determines how the different agreements should coexist. The evaluator 400 bases its determinations on insurance parameters and other (usually predefined) coexistence rules which define how two or more agreements on an object are related. Thus, the agreement evaluator 400 receives the payout signals from the several object units 100-1, 100-2, 100-3, etc., computes the proper payout compensation from those payout signals and the coexistence rules, and generates a new payout 108.

FIG. 5 illustrates how the inventor's methods and systems for generating insurances can be implemented in a computer network. An insurance company 500 can run the application server 300 that accesses customer data in a customer data base 502. The customer data base 502 preferably stores all data that is necessary for each customer 504, e.g., insured-object-specific data, user data, index data specific to the object, etc., as well as information about payments from the customer. It will be appreciated that the server 300 and data base 502 can be located at an insurance company but either or both can also be located at and run by another entity as a service to the insurance company 500.

The insurance company 500 can make and/or forward user requests to the server 300. Also, other parties advantageously can make user requests to the server 300. The cash buffer 102 can be located at a payment facilitator 506, which can be within or outside the insurance company 500. The function of the facilitator 506 is to handle payment requests that go into or out of the cash buffer 102 (not shown in FIG. 5). One or more index providers 508 provides the index series used by object units 100 running on the server 300. As indicated in FIG. 5, the index provider(s) typically access one or more index series databases 510 in developing the index used by the object units 100. It will be understood that there can also be another company or entity 512 responsible for specification and/or quality control of the index and data behind the index.

As depicted in FIG. 5, the insurance company 500, customers 504, payment facilitator 506, index provider(s) 508, and index control 512 advantageously communicate in a secure fashion through a suitable intranet or the public internet and obtain information that is presented through respective application clients running on the computers, such as otherwise conventional web browsers and graphical presentation software. Also able to communicate in the computer network are other potentially interested parties, including one or more reinsurance companies 514 and participants 516 in one or more distribution and market channels, as well as potential regulatory or other authorities 518.

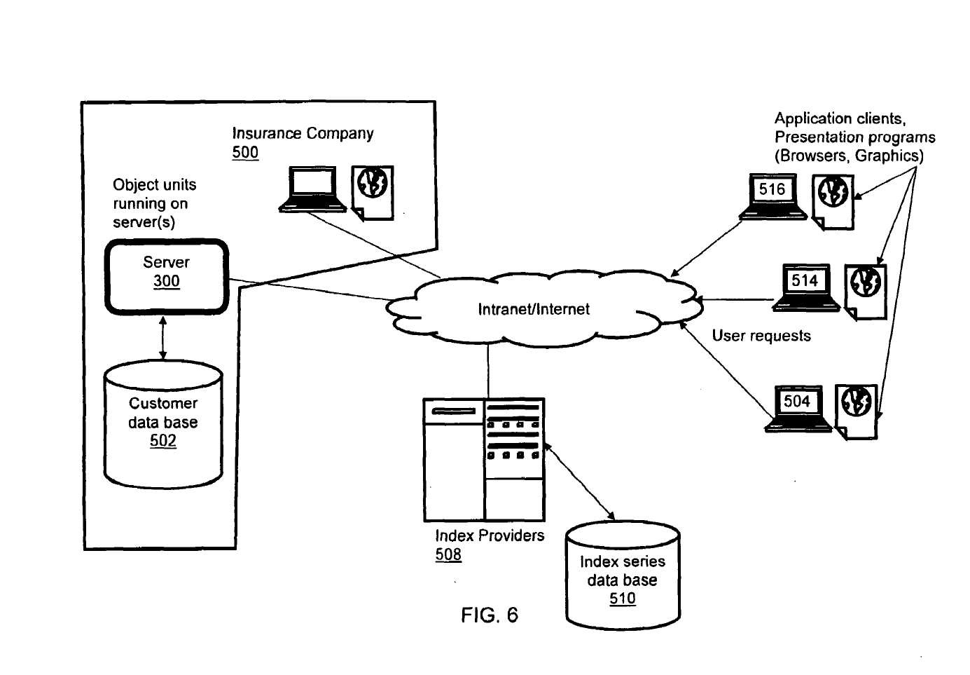

FIG. 6 illustrates how an application client at a user 504 can access the server 300 and present data based on user requests. As described above, the data advantageously can be presented graphically and/or in a text-based form.

It will be noted that the payments in the cash buffer 102 can be split among several parties as an incentive to take part in the methods and systems described. Thus, when a customer pays for an insurance, several parties can get a share of the payment directly or indirectly. Normally, a reseller or distributor (a market channel distributor 516) gets a percentage of payment. Also, the insurance company 500 gets a share of the payment, and part of it is of course retained as a security reserve. Other parties, such as reinsurance companies 514, index providers 508, and other stakeholders could get a share of the sales volume or have other mechanisms that result in their receiving payment.

Referring again to FIGS. 1, 1A, the object unit 100 is depicted with several mathematical quantities and functions that used described below to illustrate what is happening mathematically in the system.

The compensation C(t) can generally be written as follows:

C(t)=T(t)*W(t)*V(t)*I(t)

in which T(t) is a time function that reflects if insurance terms and conditions are met or not; W(t) is a compensation amplitude; V(t) is an insured value; I(t) is a time function that reflects a change in the index during a period of time.

In accordance with the preceding exemplary formula, the compensation C(t) from the market value insurance can be derived in the following manner, keeping in mind that the formula may be rewritten in several different ways, for example:

C(t)=T(n1, n2, . . . , N)*(W(t)*V(t)*I(t)+M(t))

in which C(t) is compensation, which may be called market value insurance compensation to the policy-holder; T(n) is a function of an optional parameter n that can have values in the range [0,1]; n1, n2, . . . , N are values of the optional parameter in the range [0,1]; W(t) is an optional function for compensation amplitude; V(t) is the insured value; I(t) is the change in index value; and M(t) is an optional constant or function.

In the preceding formula, the change in index value is given by:

I(t)=Max((Ia(t1)−Ib(t))/Ia(t1),0)

where the function Max (x,y) takes the value x if x y, else it takes the value y; and the times t1, t2, t3 are such that t1≦t2≦t3, with t1 the time the insurance is signed to be valid from; Ia is the index value at time t1 or optionally an index value agreed on for each time t; t2 is the time the insurance is claimed for compensation; Ib is the index value at time t2 or optionally an index value agreed on for each time t; and t3 is the time the insurance is valid to.

The function W(t) serves several useful purposes. As illustrated in FIG. 1, the compensation window first does a threshold compare, and thus W(t) can do subtractions and/or additions to the index difference. It then also can do adjustments to the index as illustrated in FIG. 1, and index adjust can multiply the difference with a factor. It will be seen that choosing suitable W(t) enables many unique features of each insurance agreement by comparing the index change to thresholds and multiplies it with factors. Thus, W(t) can implement many different functions to be able to take out the exact index difference which is needed for each specific agreement.

The insured value V(t) can for example be the value of the underlying object at the time of agreement start or the value the policy holder has bought the underlying object for. It can also be the underlying object value multiplied by a factor, e.g., an index difference.

In accordance with another embodiment, the general formula may be expanded as follows:

C′(t)=Min(C(t),N(t))

where Min (x,y) is a function that has the value of x if x≦y, else it has the value of y. The expanded compensation C′(t) can be used when the compensation amount is limited to a maximum N(t).

In yet another embodiment, the formula for I(t) can be written as follows:

I(t)=Max((Ia(t1)−Ib(t))/Ia(t1),Q(t))

where Q(t) is a constant or function and the function Max (x,y) is as described above. This form of I(t) can be useful in several situations, for example, if it is desired to reflect that compensation is not given out if the change in index has not been large enough.

The general formula for compensation can also be written as follows:

C(t)=T(n1,n2 . . . n)*(Max(W(t)−X(t),Q(t)))*V(t)*I(t)+M(t))

where X(t) is the lower limit of compensation, which can be time-dependent or constant; Q(t) is a constant or a function; and the other parameters are as described above. By introducing X(t), it is possible to limit W(t) compensation. It is currently believed to be preferable that typically Q(t)=0.

In yet another embodiment, the formula for I(t) can be written as follows:

I(t)=I1(t)+I2(t)+ . . . +Is(t)

where I(t) is a combination of different indexes I1(t), I2(t), and so on. It will be appreciated that the different indexes can be combined in many more ways than just by simple addition as shown.

A good index for use by the methods and systems in accordance with the invention has a few specific features. The index should have as little time lag as possible, and so a good index preferably is updated at least once per month. The data needed should also be gathered as early as possible, preferably when a business is set up that implements the methods and systems in accordance with this invention.

In general, a suitable index reflects the price development of objects in a certain area and/or category between start times and stop times. Index values are correlated to the price development for the group of objects. An index can be based on an object level, a regional level, or on a national level, for example. Alternatives for an index include for instance square-meter price indexes and average-price indexes for similar objects or groups of similar objects. An alternative to using such an index is to use another trigger with fixed levels of compensations depending on how the object prices develop. Thus, the index could be based on an estimate of a price level at a certain point of time (e.g., close to the start of an agreement) and then an estimate of the price level at another point of time (e.g., close to a compensation request). Such estimates can depend on several parameters, but basically they reflect price development. Thus, even without developing an index price series, one can base the operations described in this application on a change in values at least two points in time, and so the index then simply reflects the change between the two points in time. The two values can be based on parameters other than price development but they should basically reflect the price change of the object(s) and correlate with the development of an index.

An easy way to realize this same type of index functionality is to estimate price change on an object- or object-group level between times t1, t2 as illustrated in FIGS. 1, 1A. It will be noted that the estimate can be time-separated from the times t1, t2, for example by as much as several months. Thus, the estimated values used (instead of price index values) can be collected well in advance of or after the times t1 and t2, respectively. The estimated values can also be based on a prepared table of values. Thus, at certain points in time, an estimate can be made. Such estimates can be used as bases for compensation. This is also true for the index. It is anticipated that the index will have a certain time delay, and so the index values used to calculate compensation can be taken before or after times t1 and t2, respectively.

Based on different indexes that might be used, it is currently believed that a Hedonian type of transaction-based index has the features of a good index, and it can also be used for relatively small transaction volumes. The latter can be important for applications such as a regional protection. Of course, a repeated-sales index can also be used for larger populations of objects, although a repeated-sales index requires more transactions than a Hedonian type of index. In this context, a transaction is a sales transaction of object(s) underlying an insurance contract. A combination of Hedonian and repeated-sales indexes can also be used as an index.

Ideally, the Hedonian model should contain characteristics of the underlying object itself and its location, resulting in an index based on actual observed data and not appraised values. Two ways to construct a housing price index from a Hedonian model include (1) estimating a panel regression by adding a time-dependent dummy variable for each required period of time, and (2) estimating a regression without time dummy variables and running the regression for each period. A standard property is then valued for each period of time, and the index reflects the price change for the standard property. One example of a Hedonian index is the Halifax index for real estates in England.

A Hedonian equation is a regression of house prices against attributes that determine those prices and time. As described in the relevant literature, a Hedonic price equation is the following:

Y_{i,t}=Beta₀+(X_{i,t}*Bete₁)+(Tₜ*Beta₂ₜ)+epsilon_{i,t}

in which Y is the dependent variable transaction price (normally in log form); i is an identifying index; t is time; Beta₀, Beta₁, and Beta₂ are vectors of parameters (regression coefficients) associated with exogenous explanatory vector variables X; vector variable T with subscript t is a dummy variable for each period that equals one for period t and zero otherwise; and epsiloni,t is a stochastic term or vector random variable having a constant variance and normal distribution. Such Hedonian methodology is discussed in Wilhelmsson, M., “Household Expenditure Patterns for Housing Attributes: A Linear Expenditure System with Hedonic Prices”, Journal of Housing Economics Vol. 11, pp. 75-93 (2002); and Hansen, J., “Australian House Prices: A Comparison of Hedonic and Repeatsales Measures”, RDP 2006-03, Reserve Bank of Australia (2006); for example.

In such a price equation, it is typically assumed implicitly that all relevant attributes are included in the vector X; in other words, no omitted variable bias problem exists. The vector X can be decomposed into, for example, structural housing attributes and neighborhood attributes. A regression-tree approach can be used to define submarkets, and a recursive regression approach can be used as a tool to estimate how many observations are needed to make the Hedonian parameter estimates stable.

Housing markets are typically segmented into a number of different sub-markets (e.g., geographical areas/regions and/or type of houses). A housing market can also be segmented in the sense that the implicit housing attribute prices are significantly different from each other in different parts of a region, which means the price levels are different. Nevertheless, it is currently believed to be important to define sub-markets as markets where the house price appreciation is different and not necessarily the price level.

The regression-tree methodology (a variant of decision-tree methodology) uses conventional splitting rules. Regression-tree and decision-tree methodologies are discussed in De'ath, G., and Fabricius, K. E., “Classification and Regression Trees: A Powerful yet simple technique for ecological data analysis”, Ecology, Vol. 81, No. 11, pp. 3178-3192 (2000), for example. A regression tree is built through a process called binary recursive partitioning, which involves an iterative process of splitting the data into more homogeneous groups (housing sub-markets in this case), and then splitting it up further on each of the sub-markets. Initially, all of the observations are included (i.e., the whole market is regarded as one housing market), and then the data is split using binary splits. If a split is statistically significant, as determined, for instance, by a conventional F-test, then the splitting rule is applied again. Analyses of resulting sub-markets can be conducted in many different ways, but what is of interest here is whether the respective growths of house prices are different. Even if the implicit prices concerning the property attributes are different in an area, that does not necessarily bias the index for that sub-market.

By using an Hedonian index, or another suitable type of index, and at the same time splitting the housing market into different sub-markets when they have different price appreciations, it is possible to get a very good index definition with relevance to each object in a sub-market for the type of products uniquely defined. Although a housing market often exhibits high transaction costs, efficiency can create arbitrage profits due to seasonal effects, and so a seasonally adjusted property price index can be used.

It is currently believed that a ZIP area is the lowest level of geographical division that is relevant to use as to inform the customer which index he is linked to. A regional index would thus typically cover one or more ZIP areas, and there will exist a function that automatically selects the right regional index for the customer when the customer's ZIP code is entered. The level of geographical division can also be municipalities or a similar division used in different countries. Also, when the customer data, including the address or property notation (which for example can determine the ZIP code) or similar identifying information, is entered into the system, the correct index is automatically selected. In this way, the system can automatically get customer data, object data, index data, etc. based on a few key information items, such as property notation to take one example.

In accordance with aspects of this invention, a traditional insurance product can be combined with a pay-back of part of the insurance premium if the index has not gone down more than a certain limit during a period of the life of the insurance. Such a pay-back option can make the insurance product more attractive to customers. In periods when the market goes up or is stable, the customer get money back from the insurance, and in periods when the market goes down, the customer can claim compensation from the insurance if the customer sells the underlying object and risks a loss. Accordingly, in good times when the market is stable, the insurance company does not need all of the premium, which can thus be partly or fully repaid, and in bad times when the market prices are falling, the premium is locked in but the policy holder has a right to claim possible compensation.

The pay-back can be triggered by one or several triggering events, for example, the index has not been below a certain index value during the insurance period, and/or the index has not gone down more than x % during the insurance period. Other triggering events may be used. The insurance period might be split into several shorter periods, and the size of the pay-back might be triggered by several different triggers. Normally, it would be expected that a pay-back could not be claimed by the policy holder at the same time that the policy holder could claim compensation due to occurrence of an index change big enough for a claim. In addition, a pay-back could be claimed by the policy holder after the end date of the insurance period.

Thus, in a case in which there is a pay-back feature in the contract, the object unit includes a timer that starts when the agreement starts and the first payment is made. The timer then triggers the object unit to check from time to time whether the applicable pay-back criteria are met according to the set up rules for the pay-back feature. If all criteria are met, a payout is triggered. This can be expressed as another expansion of the general compensation formula above that is as follows:

C″(t)=C(t)+P(t)

in which C″(t) is the expanded compensation, C(t) is a compensation as described above (i.e., C(t) or C′(t)), and P(t) is a pay-back that can be expressed as:

P(t)=T′(n′1, n′2, . . . , N′)*P(t1)*S(t)*R(t)−Q(t)

in which T′(n) is an optional function having values in the range [0,1]; n′1, n′2, . . . , N′ are values of an optional parameter in the range [0,1]; P(t1) is the premium paid at time t1; S(t) is the pay-back part of the premium; R(t) is an optional function and reflects the value development of the premium; Q(t) is an optional function, which can for instance be excess.

The preceding formula for C″(t) can also be written as follows:

C″(t)=Max(C(t),P(t))

in which the function Max (x,y) and the other parameters are as described above. Normally, if C(t) has a value in the preceding expression, then the value of P(t) is 0 because normally one cannot claim compensation from the insurance and the premium back at the same time. If a policy holder has had the right during an insurance period to claim compensation from the insurance, the policy holder typically will not be entitled to use the pay-back option.

If the premium is paid at several occasions (for instance, monthly), the premium needs to be summed up, leading to an adjusted possible pay-back, which can be expressed as follows:

P′(t)=m(t)*Sum(P(t))

in which P′(t) is the adjusted pay-back, m(t) is an optional function that reflects that the premium is worth more paid early than late, and P(t) is as described above except that now t1 varies as a different time needs to be used for each payment. It will be understood that m(t) can be many different functions or constants. A pay-back here is to be understood in a broad sense. A pay-back need not necessarily be cash, but rather it can be a rebate, bonus, a reduction of fees, and/or any favor to the customer or the reseller. A reseller can get the pay-back, especially if the reseller has subsidized the product.

The artisan will understand that the mathematical formulas described above are tools for creating different terms and conditions applying to a particular policy for an insured object.

In general, n1, n2, . . . , N are different terms and conditions that can limit a compensation. For convenience, the values n can be normalized such that they fall in the range from 0 to 1, which can be denoted n=[0,1]. As described above, n′ is similar to n and reflects the insurance terms and conditions, but n′ is used above to calculate the sum of the premium payments for a pay-back option.

Also in general, T is a function that evaluates parameters representing different terms and conditions, with T(n1, n2, . . . , N)=1 or 0. Normally, T takes on a value of either 1 or 0, depending on whether applicable terms or conditions are met or not. For example, all terms and conditions need to be met in order for T=1. If no terms and conditions apply, T=1. If one or more terms or conditions are not met, T=0. In the above-described equations' simplest forms, T=1, effectively excluding the function. n may be time-dependent, and so the evaluation of T can be time-dependent. In some cases, it can make sense to have the possibility to give T any number and create T by multiplying different parameters at n1, . . . , N to get the value of T. As described above, T′ is similar to T, but is used above to calculate the sum of the premium payments for a pay-back option.

In general, C represents an amount of compensation, and C(t) means that the compensation is time-dependent.

W represents a compensation window that defines the compensation amplitude, and W(t) means that the compensation window is time-dependent. Normally, a compensation window is known at time t1, the agreement start, and in general, W(t) can be a combination of various functions and constants.

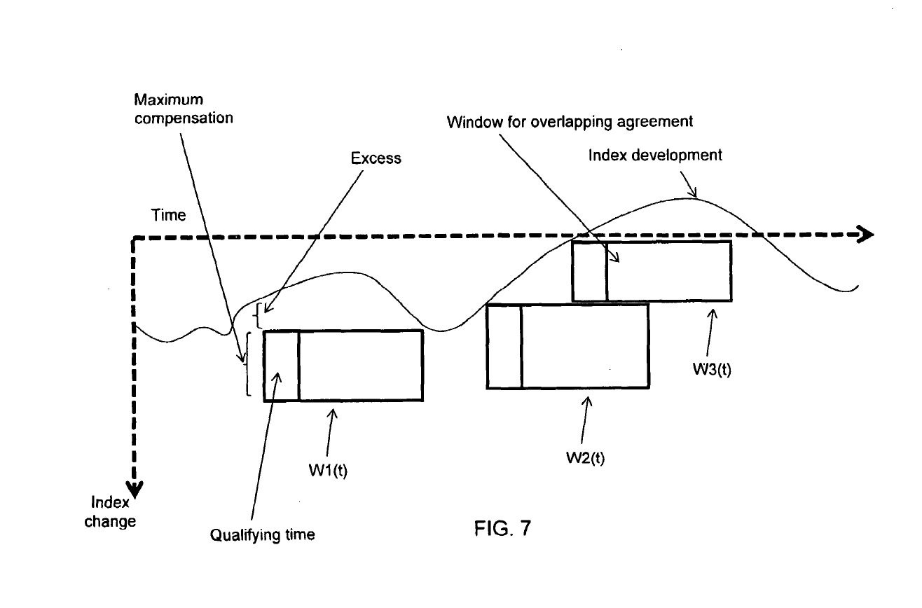

FIG. 7 illustrates a plurality of compensation windows W1(t), W2(t), and W3(t) disposed at different times, indicated by the horizontal dashed line, and different values of an index. Index change development over time is represented by the curve, which is referenced to the vertical dashed line. For each compensation window, an object unit uses subtractions, additions, factors, and multiplies by constants or functions to get the correct results according to respective insurance agreements. For instance, an agreement might specify a maximum change in index that results in compensation, or it might subtract part of an index change before determining whether compensation is due, or an agreement can provide for a payout that is a factor of the index change. These are reflected in the operation of the index adjust unit 116 of the object unit 100, for example. Compensation windows are implemented by operations of the threshold unit 114 and index adjust units 116 of the object unit 100, for example.

In the example depicted in FIG. 7, a first compensation window W1(t) corresponds to a respective customer. At the time of agreement start t1, a qualifying time period starts, which may be determined by a suitable timer. In this example, an excess over the index is also added. The qualifying time corresponds to a qualifier 110, and the excess is represented in the threshold unit 114. Also, a maximum index change that can be compensated is taken care of by the threshold unit 114.

In the example of FIG. 7, another compensation window W2(t) corresponds to another respective customer who buys a product at this customer's agreement start with the compensation window W2(t). After some time has passed, the customer upgrades the product, and a new compensation window W3(t) is added. The window W3(t) starts at a higher index level than the window W2(t) and fills out compensation also for this higher index level but relies on the former product.

Two overlapping agreements, with corresponding compensations windows W2(t) and W3(t), are illustrated in FIG. 7. In such a situation, a policy holder can, based on one agreement, buy a second agreement and “lock in” price increases in the index over the time period between the agreements that correspond to the windows W2(t), W3(t), and gradually secure the holder's underlying object(s) against a price fall on yet a higher index level. Since the policy holder already has a policy, with its saved values Ia and Vt as illustrated in FIGS. 1, 1A, and its corresponding compensation window, excess, qualifying time, etc. as illustrated in FIG. 7, this situation can be used when the new policy should be evaluated; the policy holder needs to pay “only” the premium for the index difference between the policies that correspond to W3 and W2 when the start value Vt is taken into consideration for the second policy. If the two policies that respectively correspond to W2 and W3 in FIG. 7 are the same, the second policy will be valid for the index difference between Ia (call it Ia3) for the W3 window and Ia (call it Ia2) for the W2 window. The first policy secures a start value Vt and the start index value Ia2. On top of this, a higher index value (and often a higher start value Vt) can secure yet a higher valuation of the object price. Thus, cost-efficient upgrade paths from one policy to another policy can be created. The agreement evaluator 400 can check, at a compensation request, all policies linked to an object and evaluate the compensation from the different agreements.

Thus, for the customer corresponding to windows W2(t) and W3(t), the agreement evaluator 400 (see FIG. 4) needs to evaluate both the original and upgraded agreements, i.e., the effect of each agreement and its window. From the customer's perspective, it is now possible to create a smooth upgrade path. If the customer chooses to upgrade the product, it can be done simply by adding a new agreement to the previous one. A strategy for a policy holder can be to upgrade the policy as soon as the index increases, thereby locking in higher and higher index development in a cost-efficient manner. The policy holder does not have to buy a new policy every time, but needs to pay only for the part of a new policy that corresponds to the index increase since last policy was taken. How this can be done technically is now solved.

In general, V represents the insured value, and V(t) means the insured value varies with time. An insured value is often a constant set by the agreement made at the time of signing the insurance, but it can be agreed between the insurer and the policy-holder that for example the insured value increases over the years by a known amount or percentage. The latter could for instance be the case if the insured value each year is recalculated due to market changes reflected in the index or another index. The insured value can be expressed as a nominal quantity or as a real quantity, e.g., monetary value. One may have a nominal start value Vt or a real start value Vt, and a real Vt is multiplied by a real change in monetary value when evaluating the compensation. Also, other means for expressing real compensation can be considered, e.g., coupled to the change in index instead of the insured value.

As explained above, R(t) is optional time-dependent function that reflects the value development of the premium. R(t) can be a function that follows the underlying index itself, and it can then result in compensation if the index is developing positively. It can determine a stop-loss level, so that the insurance premium can be guaranteed at a certain level after a certain period of time. It can result in no return at all if combined with a market value insurance product but result in compensation if not combined with the market value insurance. R(t) can be nominal and have a value equal to 1, or R(t) can correspond to a real entity or quantity, e.g., R(t) can be linked to the development of any index, such as an inflation index.

In general, I(t) represents the change in index values between time t1 and t2, where Ia is the index value at time t1 and Ib is the index value at time t2. The relation between Ia and Ib is the base for calculating the compensation level. If Ib has changed enough from Ia, compensation can be claimed. If the change in index is less than what is defined to give the right to compensation at a given time, a claim cannot be made. In some cases, compensation can be claimed only if the change between Ia and Ib is less than certain index points instead of more. Also, the formulas described above are generally valid if the index has a positive correlation to the market; if the index is negatively correlated to the market, then Ib(t) is larger than Ia(t) to give compensation. I(t) can also be combination of different indexes. It can be the case I(t) is formed by taking a certain percentage of one index and then another percentage of another index, and so on.

M(t) is a constant or a function that can be time dependent. M(t) can for instance represent excess (see FIG. 7), in which case M(t) would usually have a minus sign. M(t) can also be a sum to compensate for cost. M(t) is often 0. M(t) can also represent the limit of compensation, in which case it usually has a minus sign. M(t) can also represent a combination of excess and limit of compensation.

N(t) is normally a value or a function which limits the compensation of the product.

With regard to C′(t), sometimes the compensation is has a certain maximum amount N, and sometimes N depends on time t. Thus C′(t)=Min(C(t),N(t)), i.e., C(t) or N(t), whichever is less. This is useful when compensation should not be higher than a certain amount.

In general, an index reflects how a market changes and can in principle be based on almost anything as long as it is correlated to the objects in the market. Normally, an index has a positive and stable correlation to the value development of the objects in the market, but an index might instead have a negative correlation to the market and be used anyway. The index can be discrete or continuous. Unique objects are not sold often, and so it can be difficult to know the prices of objects that the index is based upon. The index can be based on valuation of the objects periodically or it can be based on repeated sell/buy transactions actually done of the same object or different objects in the same group of objects. It is currently believed preferable for the index to be based on real sell/buy transactions (repeated sales or hedonic indexes) and also to be updated in real time.

Indexes existing today are often updated quarterly, or even yearly, and in best cases, monthly. It is possible to get a real time index by using a sliding-window type of methodology to create the index values. For example, consider an index that is updated monthly. The index can be populated by data from the next month and at the same take away data from the last time period. If the number of transactions is too few to get a good index quality when updated on a monthly basis, for example, a sliding window can be used. The index can then be updated more often, but the index for a certain period of time is based on both old and new transaction data. The old data is from the period before and the new data is mixed with old data, and thus the index looks like it is “real time” but changes in the transaction data are smoothed out by mixing old and new values. Accordingly, it is possible to get real-time behavior in a transaction-based index, even with a small number of transactions. Normally, the raw data of sales transactions are bought, and an index is constructed or an existing index is used as a base for the products.

It is possible to use one known index for a group of objects or create a new index. The grouping may be based on type of objects and/or on geographical limitations. It may also be based on a similar or another index related to the group of objects. What is important is that the index reflects the price changes of the group of underlying objects in such a way that the change of the index reflects the market price change of the objects in the group.

It is preferable to select objects of a type with similar characteristics. It is further possible to limit the group of objects to a geographical region such that they show similar behavior. If the application is real estate, the index selected for a group of objects should be a good representation of the market representing the objects.

As noted above, market value changes are reflected in an index, and index values are read at least two occasions. Changes in the index between those two occasions are the basis for compensation. The index value can at least be read at the date the agreement for insurance states it starts and the date the agreement states it should end. The index value is taken on the same date the insurance starts and on the date the underlying object is sold to be used as the basis for compensation. It is also possible to use the index value on the date a loan is signed and on the date the loan is ended.

It will be noted that normally product use index values correspond to the starting time t1 and/or the end date t2. Nevertheless, sometimes the time lag between the last published index value and t1 or t2 might be so big that a modification to the index value must be done using the next index value or a mean between last published index value and the next index value. Sometimes the compensation at time t2 will be split in two parts—one part shortly after sale of the object, and the other part when the next index value is published. Thus, sometimes it can be good to use the next index value instead of the current index value to calculate compensation or to use a combination of a last-published index value and a next-published value.

In an embodiment of the invention, if a financial product is tied to an object, it is only possible to claim compensation from the new financial product described in this application if the underlying object is sold.

It will be understood that it a bank or another organization may get the right to the compensation instead of the policy holder if the policy holder cannot repay the loan amount upon sale of the object.

Compensation is linked to the market price of the underlying object at the date of taking out the insurance (buying the new financial product described here) and the difference in the new financial product index value between the time when buying the new financial product and the date of selling the underlying object. The market price of the underlying object at the date of taking out of insurance can be the following:

the estimated price of the underlying object at the date of buying the new financial product;

the price of the underlying object at the date of buying the underlying object;

the amount of the mortgage of the underlying object at the time of buying the new financial product;

the amount of mortgage of the underlying object at the time of buying the underlying object;

an amount agreed upon between seller and buyer of the new financial product

the amount might be agreed to vary with time; or

the market price of the underlying object can be set after buying the product.

The estimated market price of the underlying object at the date of buying the new financial product described here may be calculated by adding the price for the underlying object and the underlying object price multiplied by the price difference in percentage between the index value at the date the owner buys the new financial product and the date the owner bought the house.

The end value for compensation, e.g., V(t2), is the starting value multiplied by the difference of index values in percentage between the time (e.g., the date) when the new financial product described here was bought and the date when the underlying object is sold.

Compensation can be triggered by different events on their own or in combination. For example, compensation can be triggered by the sale of the underlying object for the new financial product described here; the end of a loan agreement; divorce or separation—one instead of two pays the loans and living expenses; unemployment; a relocation to new geographical area; death; illness; accident; bankruptcy; foreclosure; other reasons.

The new financial product described in this application normally gives compensation when the index value is lower when the underlying object is sold than it was when bought if all other terms and conditions are fulfilled for compensation. It could in some cases be giving compensation also when the index value is higher or the same when the object is sold than bought if the compensation window states it should. Thus, what normally triggers the compensation for the end-user is that the underlying object is sold, but other triggers may be used. When this is done, the compensation for the new financial product is calculated.

The compensation may be linked to a person other than the owner of the unique object, for instance, a lender. The policy holder can be the owner of an object, and when he sells the object the policy can be transferred to the buyer.

Thus, the product can have several different requirements in the terms and conditions, such as using the price change of the underlying object to limit the size of the compensation; using the compensation amplitude to reflect how much of the index change should be compensated; adding a qualifying period; adding an excess; adding a maximum compensation; adding a feature which pays back part of the premium or a bonus; adding other insurance terms and conditions.

Preferably a product has a qualifying period, a last validity date, and a maximum compensation. It will also in some cases be reduced if the underlying object is not sold at a loss. The compensation is normally also reduced by an index factor which reduces the payment. When the index goes down one unit, the compensation amplitude can be just half of that, or some other factor. This is done to make sure relevant level of compensation is paid out.

The product can have different payment opportunities, e.g., up-front payment, inclusion in the interest of a loan, addition to a loan, or as a fee paid regularly.

Normally, insurance products are paid for by monthly premium payments. In an aspect of this invention, the payment for this product can also be paid partly or fully up front. The product can be paid for one period at a time, up front, or be included in the interest for a bank loan on the underlying object. Adding the payment to a bank loan has an effect on the policy-holders monthly liquidity. The payment may fully or partly be included in the interest for the underlying object. The cost for the insurance could be included in the interest for part of the loan or for the whole. The government or another organization may subsidize part of the insured value to lower the cost for the policy-holder.

If an object owner has taken an insurance of the value of the object, the owner may see that it is necessary to change the insured amount, the index value, or the product, without losing the value the owner has already paid into the insurance. This adds a lot of value to the customer buying the product. The product is not just a one-time shot, but different products can be combined or linked in a chain to give the customer what the customer needs at each point in time.

An optional feature to the insurance is the possibility to change the insured amount after some time. The insurance taker may have changed the valuation of the underlying object and want to have a higher insurance value. Normally, the insurance taker can get a higher insurance value when the underlying index value has developed positively and the taker has a new valuation of the object. The insurance taker will then for a smaller fee than it would cost to take out a new insurance upgrade the insured value.

Financial products in accordance with the invention can be packaged with other insurance or saving products in very many ways. Often it can be reasonable to package the financial products together with other insurance products available today, for instance, object insurances (e.g., home-owner insurances) of different types or credit insurances of different types. The products described in this application can for instance be packaged together with traditional mortgage insurance in the United States.

This invention makes it possible to reach the market also with very low prices. Thus, the product described here can be sold in two steps. A first step, which can be called Market Value Lock, is a way for a customer to lock an index in time, with an object and insured value of the object but not having to pay the premium until later. This is a solution for low-cost, step-in type of products sold on the Internet. The customer may then later use this index value as the base for the market value insurance when paying the premium. The customer may then for example lock the index value for a period, typically between 3-12 months, with a minimum fee. The customer can then follow the development of the index for some time and decide whether to pay the premium later.

Step-in products can be made in different ways.

The period to use the right to cover the market value insurance might vary from days to years. The Market Value Lock might be formulated as an option to choose between one or several different products. The price for the market value insurance products will be known at the time when a customer buys the Market Value Lock option or soon afterwards. The Market Value Lock product could also have a feature to generate cash in case the index goes down and the person is not using his right to cover a market value insurance type of product. The customer might get the change in index in cash.

One feature of the construction of the new financial product described here is that the compensation level can be known to the buyer of the new financial product during the life time of the financial product. The reason is that all terms and conditions are known to the buyer/owner of the new financial product at the same time as the index value is known. Thus, the compensation level can be calculated each day to give the owner a good understanding how much compensation would be due if the underlying object were sold that day.

Preferably different applications are used for different market segments, such as starter-home buyers.

The Market Value Lock type of product offer enables a low-cost product with a low price to be provided to Internet customers, who can order this type of product and freeze the index value of on any given day. If the index goes down within a 6-12 month period, they can order the real market value insurance product but use the “frozen” index value of before, with an option to buy the product within a certain time.

The second step can be called Market Value Start, which is the first part of a product that which can then be extended. Typically, the Market Value Start type of product is a price fall protection for a period, e.g., 1-3 years, that is then extendable to another product.

The Market Value Start product is the first part of a split of the new financial product described here into two parts. The Market Value Start part may not be so expensive and gives a protection during a start period; the second part gives protection that the first part can be extended to. Thus, this offers the possibility to create products for customers at low risk for the company and with a benefit for the customer, who does not have to decide on the big money up front but gets a grace period. The market value start product can be bought by the seller or the buyer of an object. Within a defined time (6-24 months, typically), the buyer of the object can upgrade the product to a real market value insurance.

There are several important ways to limit the compensation level and thereby reduce the risk and capital needed to give out the new financial products described in this application. For example, the risk or compensation level can be limited:

to a number or a percentage of the insured amount (and might vary with time);

when many policy holders sell at the same time;

when the index goes down drastically;

to a smaller portion of the object value;

by later repayment of claims;

by holding part of the compensation until the final index is set or other conditions are met;

with the excess described above;

by a lower limit for the price of the insurance;

by additional payments in case index goes down drastically;

in times of crisis, war, etc.;

by using qualifying period or compensation windows;

by limiting the type of objects or geographical areas;

by limiting who can take the insurance;

other mechanisms; and

combinations of the above.

The cost for the insurance described here may also be limited in many ways, for example, by using hedging vehicle, re-insurance solutions, loan agreements in cases of index down-turns, products on more markets which vary differently, and/or other products with other risk patterns (savings products, for example).

The methods and apparatus described above can also be used to provide a sort of group insurance. One way to provide group insurance is to reduce the compensation to an end user based on an index factor that grows with the premium paid. For example, a customer might start with a base insurance that gives compensation for a portion, e.g., ten percent, of the insured value if the index goes down by a particular amount, e.g., thirty percent. The customer can then buy compensation for another 10% of the new insured value.

As described above, the present invention enables the value of a object, such as a house, a boat, a collection of items, etc., to be secured, and it will be understood that the invention can be applied to all types of unique objects, tangible or intangible, that are not traded as commodities.

Another feature or qualifier can be to limit the compensation by a value or function in such a way that the compensation is given only to those who suffer “a loss”, as the term loss may be defined, upon sale of their underlying object(s). This can be expressed for example as follows:

L(t)=the price of a house at the start of the insurance policy or at the purchase of the house−the price of the house as sold+/−other effects, e.g., tax effects, agent costs, etc. Using such an L(t), the compensation C′(t) can be given by:

C′(t)=Min(L(t),C(t))

in which Min(x,y) is a function which takes the minimum of the two values x and y; L(t) is as just described: the object value at the start (e.g., the value paid for the object) reduced by sale expenses at the end; and C(t) is the compensation from the insurance policy as before. Thus, by introducing the function L(t), it is possible to automate the calculations to make sure payouts are done only when policy holders experience losses at the underlying objects. The term “loss” should be understood in a broad sense to mean a predetermined condition with respect to a sale of the underlying object(s). A loss can be defined in different ways, and usually there is one or more thresholds related to the underlying business. If a real compensation is used for example, a “loss” may be defined to occur even if the underlying business is positive but not earning enough money. For another example, a “loss” may occur only if the person is losing more than a certain amount, or his own equity in relation to loans, etc.

Methods and apparatus in accordance with the invention can also be used in handing over the insurance policy from one policy holder or party to another. For instance, the insurance may be sponsored, and the sponsor may buy the insurance policy and hand it over to the buyer of an object. In a seller-to-buyer handover, the seller of an object may hand over the insurance policy to the buyer.

The following is an example of a normal scenario for an end customer and what then happens in the system, which may be considered in view of FIG. 5. End-customer decides to buy a product.

1. A end-customer 504 decides to buy an insurance, e.g., a price-fall insurance, as described above. Using a web browser or other suitable application client, the end-customer 504 enters personal data and data about the underlying object(s) (e.g. a house), index area, and the type of insurance product to be purchased. The index area is the geographical area in which price development is represented by the index. The data can be fed into the web client either by the end-customer or by a distributor 516, such as an insurance agent. One or several such user requests are sent to the server 300, and the data is stored in the customer data base 502.
2. The application server 300 checks the data and sends suitable confirmation data back to the customer 504. When all data is correct, the application server 300 determines the price of the insurance and offers it to the customer.
3. The end-customer 504 received the offer of the product based on the input data and the relevant index used for the underlying object(s), geographical area, and object type.
4. The end-customer 504 decides to buy the product, and does so either himself or through a reseller 516 via any of well-known Internet payment facilities, and a payment is done.
5. When confirmation of the payment is received from the payment facilitator 506, the application server 300 confirms the payment and activates the product by instantiating a respective object unit. The instance of the object unit now handles user requests about this specific customer 504, who now can see his product(s) at his web client in response to a user request to view his data.
6. After a time, the end-customer 504 sells the underlying object(s), and using the web client, the end-customer confirms the sale via a user request sent to the server 300 and sends a compensation request, i.e., the customer claims compensation according to the product's terms and conditions.
7. The instantiated object unit checks the terms and conditions of the product, and checks the current index value and saved customer, index, object, and product parameters. If all terms and conditions are met, the object unit computes the compensation and a payout request is issued to the payment facilitator 506 (and cash buffer 102). The payout 108 is sent to the customer by the payment facilitator 506, for example, and the customer can be informed by the web client when he will be paid.

An important aspect of getting new methods and systems to work is to create strong incentives for all involved parties to market and sell the products. In order to get very strong incentives, it is necessary to make sure that the pricing of the products not only considers the cost of the risk but also the cost of establishing a cash flow for all involved parties. How this can be done for the methods, systems, and products in accordance with the invention is explained below.

The system roles preferably included are insurance production, index provider 506, index quality assurance 512, insurance company 500, market channels/distributors 516, and reinsurance 514. The premiums for the insurances are split among those parties in such a way that all parties get strong incentives to do their part of the system well. The insurance company can set aside a part of the premium to match the risks in the insurance policy. The insurance company can also pay a fee to one or more reinsurance companies to take on part of the risk or pay for a hedging vehicle. The market channels/distributors can get a premium (commission) on every sale and/or also a percentage on customer payments. The insurance production company, index facilitator, and index quality assurance can get either shares of the end-user premiums or cost coverage with a premium. Thus, a cash flow is created to the parties involved. It is also important to understand that the market is created by having more money into the system than just the amount necessary for the security reserve. See illustration in FIG. 1. The payment facilitator can if automated facilitate the split of the premium, or a separate function can be established to make such splits.

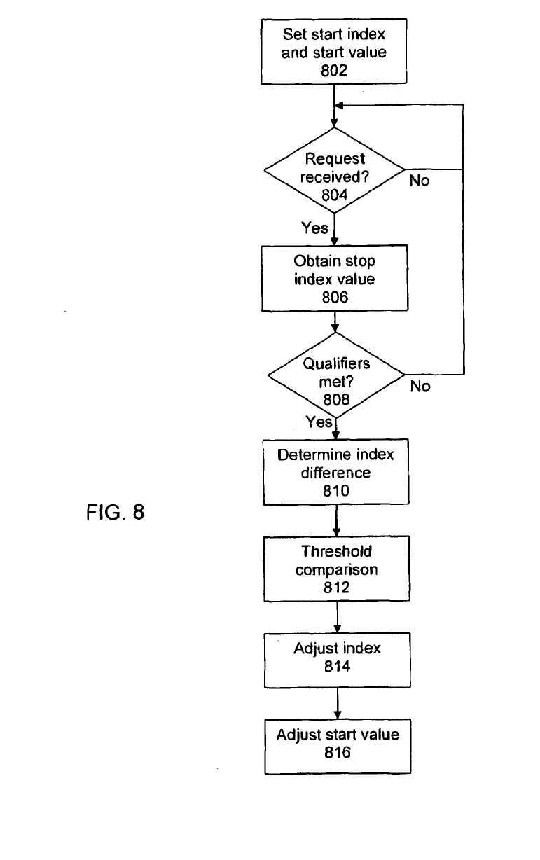

FIG. 8 is a flowchart of an exemplary method of determining a compensation for an insurance contract as described above. In step 802, a start index value Ia and a start value Vt for the insured value are set. In step 804, whether a compensation request has been received is determined. If not (No in step 804), the method flow returns, and if so (Yes in step 804), a stop index value Ib is obtained (step 806), and one or more qualifiers (e.g., applicable contract terms and conditions) are checked (step 808). If all qualifiers are met (Yes in step 808), an index difference based on the stop index value is determined (step 810). If the qualifiers are not met (No in step 808), the method flow returns. As depicted in FIG. 8, the index difference is compared to a threshold (step 812) and selectively adjusted (step 814). As explained above, the thresholding step can check if there are limitations to the size of the index difference, if there is a maximum index difference, or if there is a part of the index difference that should be removed, for example, and the index can be adjusted by multiplying the index by a factor (typically in the range of 0 to 1) or applying another function to the index, for example. Also as described above, the order of the steps 812, 814, and/or the steps 806, 808, as well as other steps in the method, can be varied. After quantification of how the index difference should affect the compensation (steps 812, 814), the start value Vt is adjusted accordingly (step 816), for example by multiplying the quantification result by the start value Vt, yielding the compensation. If desired, step 816 can include a step of limiting the compensation, for example, based on how the underlying object business is developing in itself, and/or any of the other factors described above.

The artisan will understand that the method depicted in FIG. 8 and variations of it as described above can be readily performed in a number of ways, for example, by one or more electronic processors configured by suitable programming software.

This patent application claims the benefit of the priority of U.S. Provisional Patent Applications No. 60/921,818 filed on Apr. 4, 2007, and No. 60/974,147 filed on Sep. 21, 2007, both of which are incorporated by reference in any counterpart of this application filed in the United States.

It will be appreciated that procedures described above are carried out repetitively as necessary, for example, to respond to the time-varying nature of communication channels between transmitters and receivers.

To facilitate understanding, many aspects of this invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both. Processors implementing embodiments of this invention can be included in, for example, laptop computers and other mobile terminals, as well as desktop and other computer systems.

Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

I claim:

1. A computerized system configured to determine a compensation for an insurance, comprising:
at least one object unit that receives an insured value and at least one index value and that determines the compensation according to a function of the insured value and a change in the index value over a period of time.

2. The system of claim 1, wherein the compensation C at a time t is calculated according to:
C(t)=T(n1, n2, . . . , N)*(W(t)*V(t)*I(t)
in which T(n) is a function that can have values in a range [0,1]; n1, n2, N are values in the range [0,1]; W(t) is a function for compensation amplitude; V(t) is the insured value; and I(t) is the change in index value.

3. The system of claim 2, wherein the function for the compensation C is related to an insurance premium.

4. The system of claim 1, wherein the system is configured to offer a new insurance policy in exchange for or as a supplement to an old insurance policy at a reduced premium.

5. The system of claim 1, wherein the system is configured to pay back a portion of the premium to a user if the index has not declined more than at least one threshold or the index is above at least one threshold during a period of time

6. The system of claim 1, wherein the compensation is limited by a value or function such that the compensation is given only in case of a predetermined condition with respect to a sale of the underlying object.

7. The system of claim 1, wherein compensation requires a change in index and a sell of the underlying object.

8. The system of claim 1, wherein compensation requires a change in index, a sell of the underlying object and where the amplitude of the compensation is dependent on the underlying object business.

9. The system of claim 1, wherein the system is adapted to receive an index from an index database.

10. The system of claim 9, wherein the index is a Hedonian index or a repeated-sales index, or a combination thereof.
